(19) United States
(12) Patent Application Publication
(10) Pub. No.: US 2005/0233464 A1
(43) Pub. Date: Oct. 20, 2005

(54) Methods and apparatus for identifying compounds in a sample

(75) Inventors: Bruce J. Compton, Lexington, MA (US); Robert S. Plumb, Milford, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/099,891

(22) Filed: Apr. 6, 2005

Related U.S. Application Data
(63) Continuation of application No. PCT/US03/32211, filed on Oct. 9, 2003.
(60) Provisional application No. 60/417,366, filed on Oct. 9, 2002.
(60) Provisional application No. 60/429,851, filed on Nov. 27, 2002.

(51) Int. Cl. G01N 30/02

(52) U.S. Cl. 436/161; 436/173; 422/70

(57) ABSTRACT

Embodiments of the present invention provide methods and apparatus for comparing the proteome and or metabonome of an organism or culture to standard values, over time, or after a change has taken place, a pertubation, with respect to the organinsm or culture.

### CROSS REFERENCE TO RELATED APPLICATIONS

This application is a continuation of International Application No. PCT/US03/032211, filed Oct. 9, 2003, which designated the U.S. and claims benefit of U.S. Provisional Application No. 60/417,366, filed Oct. 9, 2002, and U.S. Provisional Application No. 60/429,851, filed Nov. 27, 2002. The entire contents of the aforementioned applications are incorporated herein by reference in their entirety.

### FIELD OF THE INVENTION

The present invention relates to the field of analysis and, pharmaceutical analysis in which it is desired to understand the metabolism of drugs in the body.

### BACKGROUND OF THE INVENTION

Researchers and medical personnel desire to understand the manner in which the body metabolizes compounds having a biological effect. With such understanding, researchers and medical personnel can understand toxic and/or therapeutic effects. With such understanding, researchers and medical personnel can identify further active compounds, further chemical pathways with the potential for control or modification through appropriate drugs or suggest possible drug interactions with other drugs and chemicals.

However, the metabolism of living organisms is complex. And, labeling of compositions administered to an organism may produce incomplete results. It is desirable to have information as to changes in the concentrations of compounds which are not necessarily labeled but may have a role in the metabolic pathway.

### SUMMARY OF THE INVENTION

Embodiments of the present invention are directed to methods and apparatus for identifying one or more compounds in a sample. One embodiment, directed to a method, comprises the steps of separating a sample into a plurality of aliquots defined by retention time ranges by means of chromatography. Each retention time range is associated with one or more compounds to produce a retention time value for compounds in the sample. Next, a mass spectroscopy analysis for each of said aliquots is taken. Each mass spectroscopy analysis has one or more mass values associated with one or more compounds within the retention time range to produce a mass value for each compound. Next, each aliquot is subjected to at least one further mode of analysis to produce a further analytical value for each compound. Thus, the one or more compounds in the sample are identified by a retention time value, a mass spectra value and the further analytical value. These values facilitate comparisons over time and from different samples or normal values.

As used herein, the term “aliquot” is used in the normal chemical sense of a part of the larger sample. The term “chromatography” refers to the separation of a mixture into its component compounds as a result of the different rates at which the compounds travel through or over a stationary phase. As used herein, the term “retention time range” refers to the period of time defined by a peak or band of a compound of interest passing a point in a flow of mixture through chromatographic apparatus.

The term “mass spectroscopy” refer to methods and processes for determining the mass of a compound. A mass spectroscopy analysis will normally establish one or more masses associated with an aliquot or sample. That is one compound may have more than one mass value due to fragmentation of the compound. The mass spectra of such compound may have more than one mass value.

As used herein, further analytical values may comprise any number of techniques or processed which produce a characteristic value or values for a compound. Preferably, at least one mode of analysis, that being the further mode of analysis, produces a value which can be related to concentration or relative concentration within said sample. Where a plurality of samples are taken over time, one or more compounds identified by mass and retention time value are preferably further identified by changes in concentration over time.

The method of the present invention have special application for comparing values of one or more compounds in the sample to a data base of similar values to establish a putative identity of the compound.

The method of the present invention has further application where the samples are derived from biological tissues from one or more individuals to whom a drug has been administered or to follow the progression of a disease. The present method allows at least one compound, a drug, a metabolyte or a protein, to be identified by retention time value, mass value and relative concentration. Where the drug is metabolized to form a metabolite, the present method permits identification of the metabolite by increased concentration over time as said drug is metabolized. Or, where a disease state is characterized by a particular metabolyte or protein, or the absence thereof, such metabolyte or protein can be monitored over time.

Embodiments of the present method allow for the establishment of an organism's total metabolic constituency (metabonome) or total protein constituency (proteome) by identifiers and concentration ranges. Thus, the present invention is useful as a tool for proteomic and metabonomic research.

A further embodiment of the present invention features an apparatus for identifying at least one compound in a plurality of samples. The apparatus comprises means for separating a sample into a plurality of aliquots by means of chromatography. The means for separating the sample into aliquots does so by the retention time range associated with one or more compounds in the sample. The separation produces a retention time value for each compound. The apparatus further comprises means for obtaining a mass spectroscopy analysis for each of said aliquots. The means for obtaining a mass spectroscopy analysis produces one or more mass values associated with a compound. The apparatus further comprises means for subjecting each aliquot to at least one further mode of analysis. The at least one further mode of analysis produces a further analytical value associated with the compound. The apparatus further comprises computer means for associating the retention time value of each of the compounds with the mass value and one or more further analytical values, to facilitate comparing values. As used herein the term comparing values includes comparisons made to standard, or normal values, or values consistent with disease states, or values from the same individual over time or from different samples.

Preferably, the apparatus has at one least one means for subjecting the sample to a mode of analysis that produces a value which can be related to concentration or relative concentration within the sample. In the event the apparatus receives a plurality of samples over time, the one or more compounds identified by mass and retention times are further identified by changes in concentration over time.

As used above, “computer means” is used in a general sense to means personal and large mainframe computers. Computer means compares said one or more compounds to a data base of similar values to establish a putative identity of said compound.

Preferably, the chromatography is selected from the group consisting of liquid chromatography, supercritical fluid chromatography and gas chromatography. As used herein, liquid chromatography includes by way of example, without limitation, size-exclusion, ion-exchange, reversed-phase and normal-phase chromatography.

As used herein, mass spectroscopy includes, by way of example, without limitation, MALD-TOF, EI-MS, ESI-MS and ESI-MS/MS, APCI-MS and APCI-MS/MS, photo-ionization-MS and MS/MS.

Preferably, the further mode of analysis includes by way of example, without limitation, mass spectroscopy, nuclear magnetic resonance, FT-IR, UVNIS spectrophotometry, fluorescence, and chemi-luminescence.

The apparatus has special application wherein the samples are derived from biological tissues from one or more individuals to whom a drug has been administered, or where such individual exhibits symptoms of a disease.

The apparatus has special utility for the identification of compound identified by retention time, mass spectra and relative concentration. The compound may be a drug, drug metobolyte, normal or abnormal protein or metabolyte.

Additional features and advantages of the present invention will be described with respect to the drawings, the detailed description and examples that follow.

### BRIEF DESCRIPTION OF THE FIGURES

FIG. 1 depicts an apparatus embodying features of the present invention;

FIGS. 2a, 2b, 2c, 2d, 2e, 2f and 2g depict features of the present method and apparatus; and,

FIG. 3 is mass ionization depicting feature of the present invention.

### DETAILED DESCRIPTION OF THE INVENTION

The present invention pertains to methods and apparatus for conducting global, that is large scale, comparisons of the proteome and metabonome of an organism. Methods and apparatus of the present invention facilitate the study of one or more changes or the development of normal standards or controls in the proteome and metabonome of an organism over time and changes in the physical environment the organism is placed or in the drugs it ingests.

The present invention will be described in detail with respect to an apparatus embodying features of the present invention. Individuals skilled in the art will recognize the description and drawings depict preferred embodiments. The invention is subject to changes and modifications and should not be limited to the precise detail of the description and drawings.

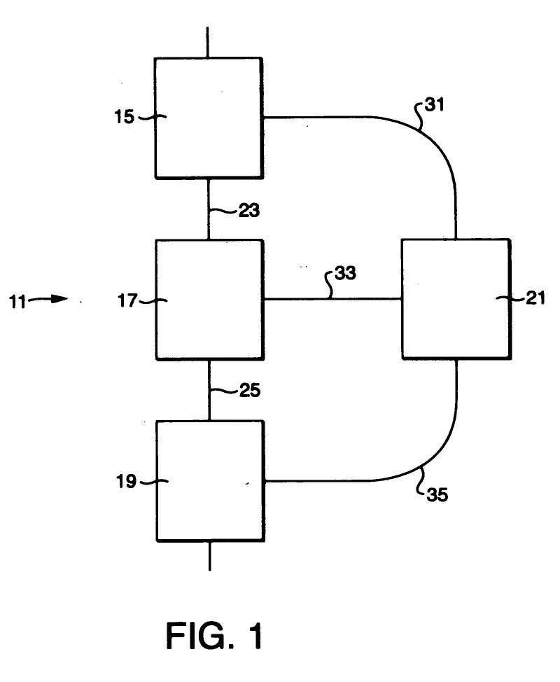

Turning now to FIG. 1, an apparatus for identifying at least one compound in a plurality of samples, generally designated by the numeral 11, is depicted. The apparatus 11 is comprised of the following major components, a chromatography assembly 15, a mass spectrometer assembly 17, a third analytical system such a UV detector assembly 19 and a computer 21.

The chromatography assembly 15, mass spectrometer assembly 17 and UV detector assembly 19 are in fluid communication via conduits 23 and 25. It will be understood that the order of the mass spectrometry assembly 17 and UV detector 19 is a matter of personal preference and can be reversed. Retention values, mass values, and UV data values are communicated to computer 21 via lines 31, 33 and 35. It will be recognized that computers and analysis equipment may also communicate via wireless networks and the like and the line 31, 33 and 35 are intended to represent all forms of communication.

One or more samples is received by the chromatography assembly 15. Chromatography assembly 15 separates a sample into a plurality of aliquots by means of chromatography. Preferably, the chromatography is selected from the group consisting of liquid chromatography, supercritical fluid chromatography and gas chromatography. As used herein, liquid chromatography includes by way of example, without limitation, size-exclusion, ion-exchange, reversed-phase and normal-phase chromatography. One preferred chromatography assembly 15 is an ALLIANCES autosampler and pump assembly (Waters Corporation, Milford, Mass., USA) equipped with suitable columns and detectors.

The chromatography assembly 15 receives samples and separates each sample into aliquots by a retention time range associated with one or more compounds. That is, the components of the sample are separated into bands or peaks defined by retention times. Individuals skilled in the art will recognize that such retention times will vary with solvent composition and differences in the solid phase in which the separation is achieved, i.e. column solid phase. However, for a given composition, solvent and solid phase, the retention time can be well defined and reproducible. Thus, the chromatography assembly 15 produces a retention time value for each compound which retention time is received by computer 21.

The apparatus further comprises means for obtaining a mass spectroscopy analysis for each of said aliquots. The means for obtaining a mass spectroscopy analysis is mass spectrometer 17. Mass spectrometers are available from several venders and may comprise MALD-TOF, EI-MS, ESI-MS and ESI-MS/MS, APCI-MS and APCI-MS/MS, photo-ionization-MS and MS/MS. A preferred mass spectrometer is a QUATTRO MICRO™, Q-TOF™, QUATTRO PREMIER™ and ZQ™ brand mass spectrometers sold by Waters Corporation (Milford Mass., USA).

Mass spectrometer 17 produces one or more mass values associated with a compound. The one or more mass values are sent to computer 21 and stored in memory with the associated retention time value. The apparatus further comprises means for subjecting each aliquot to at least one further mode of analysis.

The apparatus 11 has at least one further mode of analysis that produces a further analytical value associated with the compound. As depicted, such further mode of analysis is UV detector 19. However, other modes of analysis could be substituted for UV detector 19 such as mass spectroscopy, nuclear magnetic resonance, FT-IR, UV/VIS spectrophotometry, fluorescence, and chemi-luminescence. A preferred UV detector is a 2996™ UV detector sold by Waters Corporation (Milford, Mass., USA).

UV detector 19 is in communication with mass spectrometer 17 via conduit 25 to receive a sample or an aliquot of the sample. The UV detector 19 discharges the aliquot or sample through a discharge conduit [not shown].

The UV detector 19 produces a further analytical value, UV absorbtion, that is characteristic of the compound that is being sensed. This second value, directed to the intensity of the reading, can provide an indication of concentration or relative concentration over time or between samples. The relative concentrations can also be inferred from conventional chromatography values related to peak size and area. These values are sent to computer 21.

Computer 21 receives signals corresponding to the retention values, mass value, UV absorption and intensity and associates the mass value, UV values and intensity value with a retention value. The retention value, mass value and UV value are characteristic of a compound. The intensity value allows computer 21 to track such compound over time. The retention time, mass value and UV absorption value allow the compound to be tracked or monitored through different samples and to be compared to standard, or normal, or averaged values stored in a data base. As used herein the term “comparing values” includes comparisons made to standard, or normal values, or values consistent with disease states, or values from the same individual over time or from different samples. Preferably, the computer 21 has a monitor or print to display values and results.

The operation of the apparatus 11 will be discussed with respect to the method of operation and use. Chromatography assembly 15 receives a sample and through chromatographic processes produces a retention time value. The aliquot associated with the retention time value is then received by mass spectrometer 17. Mass spectrometer 17 produces a mass value. The retention time value and the mass value are sent to the computer 21 and used an identifier for the one or more compound associated with such values. For example, the computer 21 will associate the retention time of a peak with a mass value. One manner of association is set forth below:
[A, B].

As used above, at least one of A and B is a retention time value and the remaining value is a mass value. Those skilled in the art of chromatography will recognize that different chromatography conditions may result in different retention values. The associated mass value provides a means for matching identifying characteristics, with different retention values from different chromatography conditions, to one mass value to a single chemical entity or compound.

The aliquot associated with the retention time value and mass value is next received by a further analytical means, such as UV detector 19. UV detector 19 produces a further characteristic value associated with the compound of the retention time. This UV absorbance value is associated with the retention time and mass value as a further identifying characteristic. One manner of association is set forth below:
[A, B, C].

As used above, at least one of A, B and C is a retention time value and one of the remaining value is a mass value, and one of the further remaining values is the UV absorbance value. Those skilled in the art of chromatography will recognize that the order in which these values may be recorded, stored and processes is arbitrary. Those skilled in the art will further recognize that the number of further detectors and characteristic values is endless.

Preferably, at least one value is a concentration or relative concentration value. For example, the UV detector may provide a value of intensity of signal related to the concentration of a compound associated with the retention value. One manner of association is set forth below:
[A, B, C, D].

As used above, at least one of A, B, C and D is a retention time value; one of the remaining value is a mass value; one of the further remaining values is the UV absorbance value; and one of the values is a concentration of relative concentration value.

Where it is desired to monitor metabolism or changes in the proteome or genome over time, it is useful to add a time value to the associated values. This time value allows the tracking of the retention time compound over time. For example, a retention time may be associated with the administration of a drug. The drug may be cleared from the body over time leading to changes in concentration which can be tracked. The compound may be a metabolyte which appears in a run of sample associated with a retention time. The metabolyte can be tracked over time. One manner of association is set forth below:
[A, B, C, D, E].

As used above, at least one of A, B, C, D and E is a retention time value; one of the remaining value is a mass value; one of the further remaining values is the UV absorbance value; one of the values is a concentration of relative concentration value; 30 and one of the values is a time value.

In addition, the values obtained may also be compared to normal values or an average value stored in the computer 21 from a database of large numbers of similar samplings.

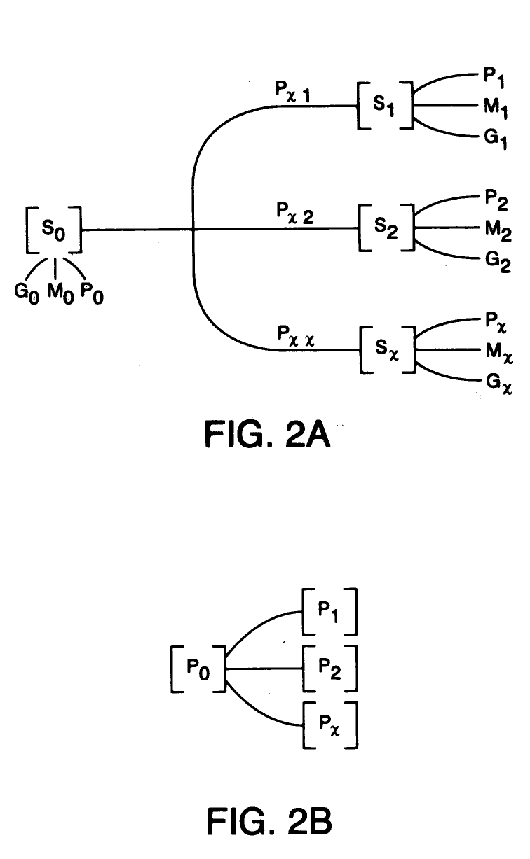

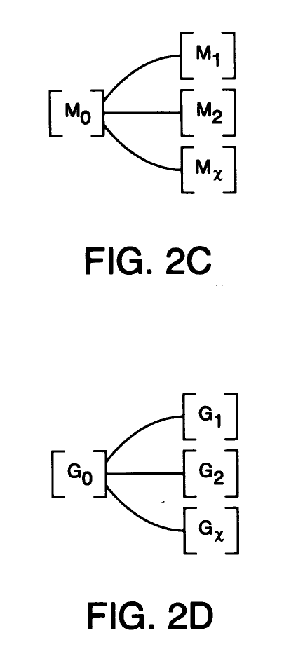

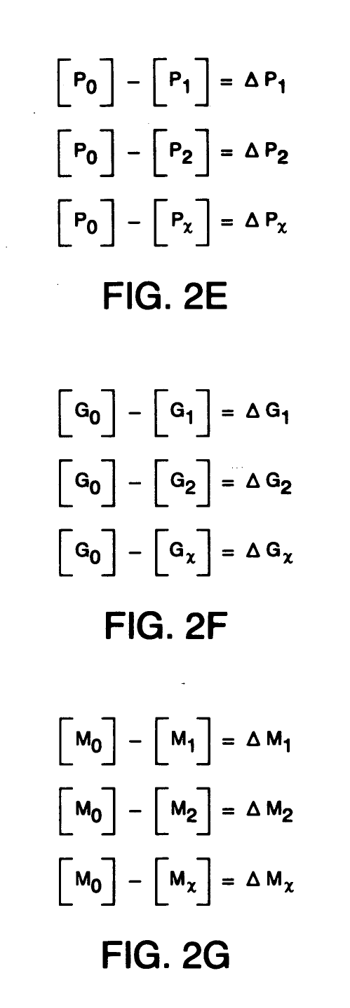

Turning now to FIG. 2a through 2d, such Figure illustrates one embodiment of the present invention. Specifically referring to FIG. 2a, the original biological sample (which can be comprised of a set of samples taken to be normal or a composite of normal samples) [Sₒ]. This sample [Sₒ] will have compounds defining a retention time, mass value and UV value, and relative concentration. If the origin of the sample is subjected to perturbation by using, for example, a pharmaceutical agent, chemical agent, or alteration of physical conditions (heat, cold, etc.) the origin may be sampled for changes over time yielding a first sample, [S₁], a second sample, [S₂], as well as any other further samples denoted by the subscript “x” [Sₓ]. New compounds defining new retention times (Rₓ₁, Rₓ₂, Rₓₓ) may be identified over time. The sample, including the base or original sample [Sₒ], can be directed to a proteome “[P]”, a metabonome “[M]” or a genome “[G]” component. wherein a sample is equivalent to its constituent components, such that [S]=[G], [P], [M], wherein [G] [symbol] [P] [symbol] [M]. The respective sample components are analyzed and identified using the compound annotation scheme articulated above.

In alternative embodiments, combinations of the three classes of biochemical molecules are analyzed, for example, one aspect of the present invention relates to only the proteome and metabonome being analyzed. Other permutations of biochemical class analysis can be realized and effectuated by those skilled in the art. In other embodiments only one biochemical class is analyzed, for example only the proteome or only the metabonome is analyzed.

Once values for the proteomes (“P”) from the different samples have been determined, then comparative analysis can be performed using an appropriate statistical method such as principle component analysis (PCA). In general, PCA is used for one-to-one comparisons. However, the most appropriate application of PCA is to use a “learning set” of a number of samples to develop a reference data set and then to compare test data sets to the learning or reference set. This allows one to determine if a given test set is significantly different from a population of “normals”.

In the present invention, the compound annotation scheme will allow a practitioner to follow various proteomic elements as between the different samples examined.

In FIG. 2e, the proteomes of the different samples are compared against each other including the original sample (or sample set). This comparative analysis facilitates the detection of detectable changes in the proteome between, for example, the original sample or sample set (Sₒ) and one or more of the treated samples (S₁, S₂, etc.). The same is true for the metabonome (“M”) and genome (“G”) as depicted in FIGS. 2f and 2g respectively.

FIGS. 2e, 2f and 2g illustrate the mechanism underlying FIGS. 2b through 2d. In order to ascertain changes in any one of the sample components, the individual component is compared with its respective normative value, i.e., [Pₒ], [Gₒ], or [Mₒ]. Changes in one sample component may reflect changes in other sample components. For example, changes in the genome [Gₒ] can result in changes in the proteome [Pₒ] which can affect the metabonome [Mₒ].

The analytical method presented herein accelerates understanding at the cellular and biochemical levels. By analyzing the proteome and metabonome in such a fashion as that described herein, the practitioner can relate, for example, changes in the metabonome with that observed in the proteome. Thus, facilitating the understanding of what elements of the proteome affect changes observed in the metabonome. And as every molecular biologist is aware, changes in the genome (“G”) can dramatically influence the proteome.

### EXAMPLE 1

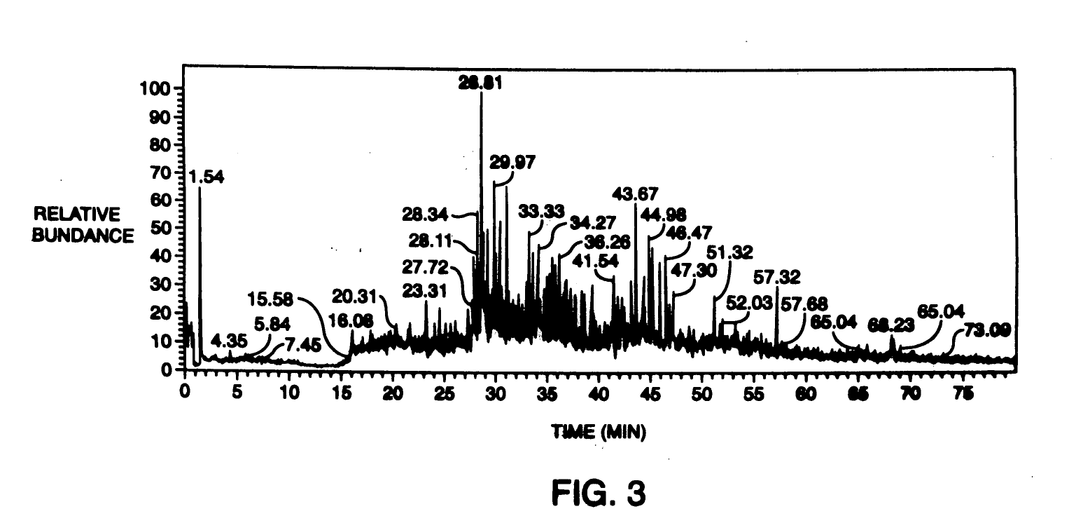

FIG. 3 is mass ionization for Sample Identifier: 1.3.2.5.40 [Breast Cancer Patient Urine Sample], Compound annotation: RT 27.72-28.64

Individual Data Record for Sample 1.3.2.5.40:

| | | 1° Annotation | 2° Annotation* | | |
|---|---|---|---|---|---|
| RRT | m/z | (MS) | (MS/MS) | Intensity | Identifier |
| — | — | — | — | | 1.3.2.5.40 |
| — | — | — | — | | 1.3.2.5.40 |
| 27.72 | 651.183 | 27.72.651.183 | 27.72.651.183.354 | 23434 | 1.3.2.5.40 |
| 27.83 | 769.274 | 27.83.769.274 | — | 3432134 | 1.3.2.5.40 |
| 27.98 | 705.323 | 27.98.705.323 | — | 34234 | 1.3.2.5.40 |
| 28.11 | 662.222 | 28.11.662.222 | — | 343 | 1.3.2.5.40 |
| 28.34 | 783.251 | 28.34.783.251 | — | 213434 | 1.3.2.5.40 |
| 28.54 | 654.355 | 28.54.654.355 | — | 3424 | 1.3.2.5.40 |
| 28.64 | 754.324 | 28.64.754.324 | — | 23443 | 1.3.2.5.40 |
| — | — | — | — | — | — |
| — | — | — | — | — | — |
| — | — | — | — | — | — |

*2° In this example, annotation from MS/MS data is produced when ambiguity is found in the 1° Annotation, due to redundancy in the annotation based on RRT and MS. This annotation is based on the mass of the primary secondary ion.

Thus, the methods described herein promote the understanding of the interrelationships between the metabonome, proteome, and genome. It should be pointed out that the elucidation of the genome, though amenable to the methods described herein, can be accomplished with relative ease employing known molecular techniques well appreciated by those in the art.

These and other features and advantages will be readily apparent to those individuals skilled in the art from a reading of the present specification and viewing the drawings. Therefore the present invention should not be limited to the precise details but should encompass the subject matter of the following claims.

1. A method of identifying one or more compounds in a sample, comprising the steps of:
a) separating a sample into a plurality of aliquots defined by retention time ranges by means of chromatography, each retention time range associated with one or more compounds, to produce a retention time value for said compounds;
b) obtaining a mass spectroscopy analysis for each of said aliquots, each mass spectroscopy analysis having one or more mass values associated with one or more compounds within said retention time range, to produce a mass value for each compound; and,
c) subjecting each aliquot to at least one further mode of analysis, to produce a further analytical value for each compound, wherein said one or more compounds in said sample are identified by retention time value, mass spectra value and said further analytical value, to facilitate comparing values over time and from different samples.

2. The method of claim 1 wherein at least one mode of analysis produces a value which can be related to concentration or relative concentration within said sample.

3. The method of claim 2 wherein a plurality of samples are taken over time, and one or more compounds identified by mass and retention time value are further identified by changes in concentration over time.

4. The method of claim 1 wherein said one or more compounds is compared to a data base of similar values to establish a putative identity of said compound.

5. The method of claim 1 wherein said chromatography is selected from the group consisting of liquid chromatography, supercritical fluid chromatography and gas chromatography.

6. The method of claim 5 wherein said liquid chromatography is selected from the group consisting of size-exclusion, ion-exchange, reversed-phase and normal-phase.

7. The method of claim 1 wherein said mass spectroscopy is selected from the group consisting of MALD-TOF, EI-MS, ESI-MS and ESI-MS/MS, APCI-MS and APCI-MS/MS, photo-ionization-MS and MS/MS.

8. The method of claim 1 wherein said further mode of analysis is selected from the group consisting of mass spectroscopy, nuclear magnetic resonance, FT-IR, UV/VIS spectrophotometry, fluorescence, and chemi-luminescence.

9. The method of claim 3 wherein said samples are derived from biological tissues from one or more individuals to whom a drug has been administered.

10. The method of claim 9 wherein at least one compound identified by retention time value, mass value and relative concentration is said drug.

11. The method of claim 10, wherein said drug is metabolized to form a first metabolite and said first metabolite exhibits increased concentration over time as said drug is metabolized.

12. An apparatus for identifying at least one metabolites in a plurality of samples taken over time in which a drug is administered to an individual, comprising:
a) means for separating a sample into a plurality of aliquots by means of chromatography, said means for separating said sample into aliquots by retention time range associated with one or more compounds in the sample, to produce a retention time value for said one or more compounds;
b) means for obtaining a mass spectroscopy analysis for each of said aliquots, said means for obtaining a mass spectroscopy analysis producing one or more mass value associated with a compound;
c) means for subjecting each aliquot to at least one further mode of analysis, said at least one further mode of analysis producing a further analytical value associated with said compound;
d) computer means for associating said retention time value of each of said compounds with said mass values and said one or more further analytical values, to facilitate comparing values over time and from different samples.

13. The apparatus of claim 12 wherein at one least one means for subjecting said sample to a mode of analysis produces a value which can be related to concentration or relative concentration within said sample.

14. The apparatus of claim 12 wherein said apparatus receives a plurality of samples over time, and one or more compounds identified by mass and retention times are further identified by changes in concentration over time.

15. The apparatus of claim 12 wherein said computer means compares said one or more compounds to a data base of similar values to establish a putative identity of said compound.

16. The apparatus of claim 12 wherein said chromatography is selected from the group consisting of liquid chromatography, supercritical fluid chromatography and gas chromatography.

17. The apparatus of claim 12 wherein said liquid chromatography is selected from the group consisting of size-exclusion, ion-exchange, reversed-phase and normal-phase.

18. The apparatus of claim 12 wherein said mass spectroscopy is selected from the group consisting of MALD-TOF, EI-MS, ESI-MS and ESI-MS/MS, APCI-MS and APCI-MS/MS, photo-ionization-MS and MS/MS.

19. The apparatus of claim 12 wherein said further mode of analysis is selected from the group consisting of mass spectroscopy, nuclear magnetic resonance, FT-IR, UV/VIS spectrophotometry, fluorescence, and chemi-luminescence.

20. The apparatus of claim 14 wherein said samples are derived from biological tissues from one or more individuals to whom a drug has been administered.

21. The apparatus of claim 20 wherein at least one compound identified by retention time, mass spectra and relative concentration is said drug.

22. The apparatus of claim 21, wherein said drug is metabolized to form a first metabolite and said first metabolite exhibits increased concentration over time as said drug is metabolized.
